(19) United States
(12) Patent Application Publication
(10) Pub. No.: US 2025/0280338 A1
(43) Pub. Date: Sep. 4, 2025

(54) COMMUNICATION CONTROL METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/198,692

(22) Filed: May 5, 2025

Related U.S. Application Data
(63) Continuation of application No. PCT/JP2023/039406, filed on Nov. 1, 2023.
(60) Provisional application No. 63/421,715, filed on Nov. 2, 2022.

(51) Int. Cl. H04W 36/00; H04W 36/36

(52) U.S. Cl. CPC H04W 36/0072; H04W 36/0079; H04W 36/362

(57) ABSTRACT

In an aspect, a communication control method is used in a cellular communication system. The communication control method includes transmitting, by a base station, a conditional reconfiguration to a user equipment. The communication control method includes executing, by the user equipment, a conditional handover after a predetermined amount of time has elapsed since detection of a predetermined condition. Here, the detection of the predetermined condition is either satisfaction of a trigger condition included in the conditional reconfiguration or reception of an execution instruction for the conditional handover from the base station. The predetermined amount of time is an amount of time different for each of the user equipments.

### RELATED APPLICATIONS

The present application is a continuation based on PCT Application No. PCT/JP2023/039406, filed on Nov. 1, 2023, which claims the benefit of U.S. Provisional Patent Application No. 63/421,715 filed on Nov. 2, 2022. The content of which is incorporated by reference herein in their entirety.

### TECHNICAL FIELD

The present disclosure relates to a communication control method used in a cellular communication system.

### BACKGROUND

The Third Generation Partnership Project (3GPP), which is a standardization project of a cellular communication system, has studied the introduction of a new relay node referred to as an Integrated Access and Backhaul (IAB) node (for example, see Non-Patent Document 1). One or more relay nodes are involved in communication between a base station and a user equipment and perform relay for the communication.

### CITATION LIST

### Non-Patent Literature

Non-Patent Document 1: 3GPP TS 38.300 V17.2.0 (2022-09)

### SUMMARY

In a first aspect, a communication control method is used in a cellular communication system. The communication control method includes transmitting, by a network node, a conditional reconfiguration to user equipments. The communication control method includes executing, by each of the user equipments, a conditional handover after a predetermined amount of time has elapsed since detection of the predetermined condition. Here, the detection of the predetermined condition is either satisfaction of a trigger condition included in the conditional reconfiguration or reception of an execution instruction for the conditional handover from the network node. The predetermined amount of time is an amount of time different for each of the user equipments.

In a second aspect, a communication control method is used in a cellular communication system. The communication control method includes configuring, by a network node, Physical Random Access Channel (PRACH) resources for user equipments. The communication control method includes transmitting, by a user equipment of the user equipments, a PRACH by using a PRACH resource of the PRACH resources configured for the user equipment when executing a conditional handover. Here, the PRACH resource is a resource different for each of the user equipments.

In a third aspect, a communication control method is used in a cellular communication system. The communication control method includes transmitting, to user equipments by a network node, a conditional reconfiguration including beam information representing a beam to be used by a user equipment of the user equipments. The communication control method includes transmitting, by the user equipment, a PRACH by using a resource associated with the beam when executing a conditional handover. Here, the beam is a beam different for each of the user equipments.

In a fourth aspect, a communication control method is used in a cellular communication system. The communication control method includes transmitting, by user equipments, PRACHs (Msgls) to a target cell when executing a conditional handover. The communication control method includes transmitting, by the target cell, random access responses (Msg2s) to the user equipments at timings different for each of the user equipments.

The communication control method includes transmitting, by the user equipments, RRC reconfiguration complete (RRCReconfigurationComplete) messages (Msg3s) to the target cell at timings different for each of the user equipments.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, Parent nodes, and Child nodes.

FIG. 3 is a diagram illustrating a configuration example of a gNB (base station) according to the embodiment.

FIG. 4 is a diagram illustrating a configuration example of an IAB node (relay node) according to the embodiment.

FIG. 5 is a diagram illustrating a configuration example of a UE (user equipment) according to the embodiment.

FIG. 6 is a diagram illustrating an example of a protocol stack related to an RRC connection and a NAS connection of an IAB-MT.

FIG. 7 is a diagram illustrating an example of a protocol stack related to an F1-U protocol.

FIG. 8 is a diagram illustrating an example of a protocol stack related to an F1-C protocol.

FIGS. 9A and 9B are diagrams illustrating an example of full migration according to a first embodiment.

FIGS. 10A and 10B are diagrams illustrating an example of full migration according to the first embodiment.

FIG. 11 is a diagram illustrating an operation example according to the first embodiment.

FIG. 12 is a diagram illustrating the operation example according to the second embodiment.

FIG. 13 is a diagram illustrating an operation example according to a third embodiment.

FIG. 14 is a diagram illustrating an operation example according to a fourth embodiment.

FIG. 15 is a flowchart illustrating an operation example according to a fifth embodiment.

FIG. 16 a diagram illustrating scenarios and subcases for UE cell reselection.

FIG. 17 a diagram illustrating a configuration of RACH-less handover using information of applicable timing advance (TA) and an uplink grant in MobilityControl Info in LTE.

### DESCRIPTION OF EMBODIMENTS

A cellular communication system according to an embodiment will be described with reference to the drawings. In the description of the drawings, the same or similar parts are denoted by the same or similar reference signs.

### First Embodiment

### Configuration of Cellular Communication System

A configuration example of the cellular communication system according to an embodiment is described. A cellular communication system 1 according to an embodiment is a 3GPP 5G system. Specifically, a radio access scheme in the cellular communication system 1 is a New Radio (NR) being a 5G radio access scheme. Note that Long Term Evolution (LTE) may be at least partially applied to the cellular communication system 1. A future cellular communication system such as 6G may be applied to the cellular communication system 1.

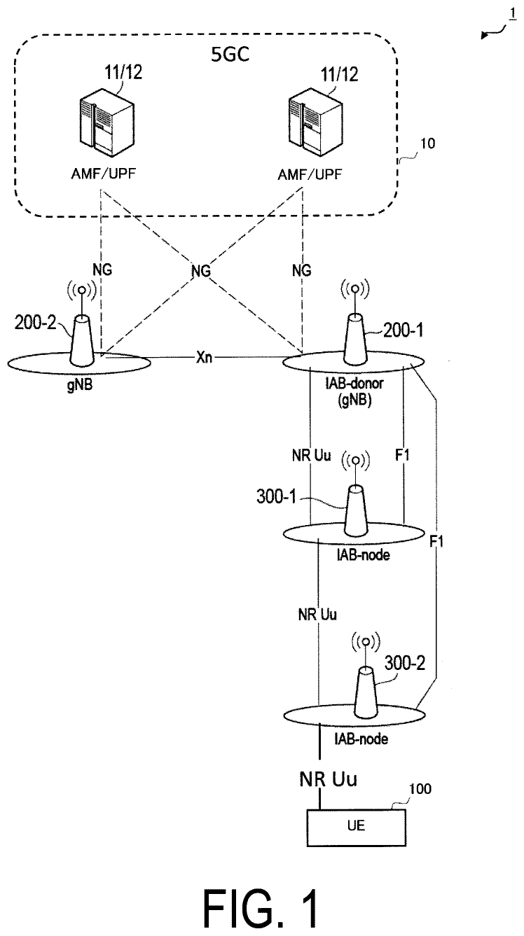

FIG. 1 is a diagram illustrating a configuration example of the cellular communication system 1 according to the embodiment.

As shown in FIG. 1, the cellular communication system 1 includes a 5G core network (5GC) 10, a User Equipment (UE) 100, base station apparatuses (hereinafter may be referred to as “base stations”) 200-1 and 200-2, and IAB nodes 300-1 and 300-2. The base station 200 may be referred to as a gNB.

In the following, an example in which the base station 200 is an NR base station will be mainly described, but the base station 200 may also be an LTE base station (that is, an eNB).

In the following, the base stations 200-1 and 200-2 may be referred to as gNBs 200 (or base station 200), and the IAB nodes 300-1 and 300-2 may be referred to as IAB nodes 300.

The 5GC 10 includes an Access and Mobility Management Function (AMF) 11 and a User Plane Function (UPF) 12. The AMF 11 is an apparatus that performs various mobility controls for the UE 100. The AMF 11 communicates with the UE 100 using Non-Access Stratum (NAS) signaling to manage information on an area in which the UE 100 exists. The UPF 12 is an apparatus that performs transfer control of user data, and the like.

Each gNB 200 is a fixed radio communication node and manages one or more cells. The term “cell” is used to indicate a minimum unit of a radio communication area. The term “cell” may be used to indicate a function or resource for performing radio communication with the UE 100. One cell belongs to one carrier frequency. Hereinafter, a cell and a base station may be used without distinction.

Each gNB 200 is interconnected with the 5GC 10 via an interface referred to as an NG interface. FIG. 1 illustrates two gNBs, that is, a gNB 200-1 and a gNB 200-2, connected to the 5GC 10.

Each gNB 200 may be divided into a Central Unit (CU) and a Distributed Unit (DU). The CU and the DU are interconnected via an interface referred to as an F1 interface. An F1 protocol is a communication protocol between the CU and the DU, and includes an F1-C protocol, which is a control plane protocol, and an F1-U protocol, which is a user plane protocol.

The cellular communication system 1 supports IAB, which enables radio relay of NR access using an NR for backhaul. The donor gNB 200-1 (or donor node; hereinafter may be referred to as “donor node”) is a terminal node of the NR backhaul on the network side, and is a donor base station having additional functions for supporting IAB. The backhaul is capable of multi-hopping via a plurality of hops (that is, a plurality of IAB nodes 300).

FIG. 1 illustrates an example in which the IAB node 300-1 is wirelessly connected to the donor node 200-1, the IAB node 300-2 is wirelessly connected to the IAB node 300-1, and the F1 protocol is transmitted by two backhaul hops.

The UE 100 is a mobile radio communication apparatus that performs radio communication with a cell. The UE 100 may be any apparatus that performs radio communication with the gNB 200 or the IAB node 300. For example, the UE 100 is a mobile phone terminal and/or a tablet terminal, a laptop PC, a sensor or an apparatus provided in a sensor, a vehicle or an apparatus provided in a vehicle, or an aircraft or an apparatus provided in an aircraft. The UE 100 is wirelessly connected to the IAB node 300 or the gNB 200 via an access link. FIG. 1 illustrates an example in which the UE 100 is wirelessly connected to the IAB node 300-2. The UE 100 indirectly communicates with the donor node 200-1 via the IAB node 300-2 and the IAB node 300-1.

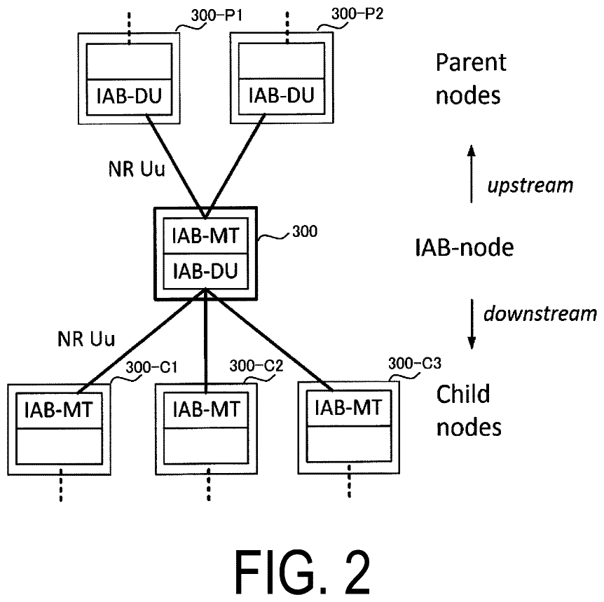

FIG. 2 is a diagram illustrating an example of a relationship between the IAB node 300, Parent nodes, and Child nodes.

As illustrated in FIG. 2, each IAB node 300 includes an IAB-DU equivalent to a base station function unit and an IAB-MT (Mobile Termination) equivalent to a user equipment function unit.

Adjacent nodes (that is, upper nodes) on an NR Uu radio interface of the IAB-MT are referred to as parent nodes. The parent node is a DU of a parent IAB node or the donor node 200. A radio link between the IAB-MT and the parent node is referred to as a backhaul link (BH link). FIG. 2 illustrates an example in which the parent nodes of the IAB node 300 are IAB nodes 300-P1 and 300-P2. A direction toward the parent nodes is referred to as upstream. From the perspective of the UE 100, the upper node of the UE 100 may correspond to a parent node.

Adjacent nodes (that is, lower nodes) on the NR access interface of the IAB-DU are referred to as child nodes. The IAB-DU manages the cell, similar to the gNB 200. The IAB-DU terminates the NR Uu radio interface to the UE 100 and the lower IAB nodes. The IAB-DU supports the F1 protocol to the CU of the donor node 200-1. FIG. 2 illustrates an example in which the child nodes of the IAB node 300 are IAB nodes 300-C1 to 300-C3, but the child node of the IAB node 300 may also include the UE 100. A direction toward the child nodes is referred to as downstream.

All of the IAB nodes 300 connected to the donor node 200 via one or more hops form a Directed Acyclic Graph (DAG) topology (hereinafter may be referred to as “topology”) with the donor node 200 as the root. In this topology, as illustrated in FIG. 2, adjacent nodes on the IAB-DU interface are child nodes, and adjacent nodes on the IAB-MT interface are parent nodes. The donor node 200 performs central management including resource, topology, and route management of the IAB topology. The donor node 200 is a gNB that provides network access to the UE 100 via a network of backhaul links and access links.

### Configuration of Base Station

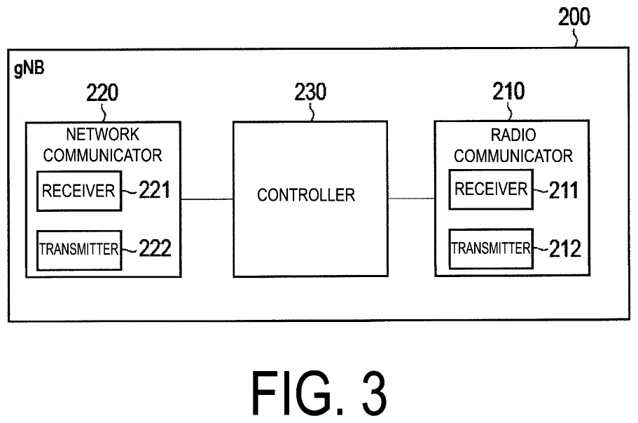

The configuration of the gNB 200, which is a base station according to the embodiment, will be described. FIG. 3 is a diagram illustrating a configuration example of the gNB 200. As illustrated in FIG. 3, the gNB 200 includes a radio communicator 210, a network communicator 220, and a controller 230.

The radio communicator 210 performs radio communication with the UE 100 and the IAB node 300. The radio communicator 210 includes a receiver 211 and a transmitter 212. The receiver 211 performs various types of reception under the control of the controller 230. The receiver 211 includes an antenna, and converts (down-converts) a radio signal received by the antenna into a baseband signal (reception signal) and outputs the signal to the controller 230. The transmitter 212 performs various types of transmission under the control of the controller 230. The transmitter 212 includes an antenna, and converts (up-converts) a baseband signal (transmission signal) output by the controller 230 into a radio signal and transmits the signal from the antenna.

The network communicator 220 performs wired communication (or radio communication) with the 5GC 10 and wired communication (or radio communication) with other adjacent gNBs 200. The network communicator 220 includes a receiver 221 and a transmitter 222. The receiver 221 performs various types of reception under the control of the controller 230. The receiver 221 receives a signal from the outside and outputs the reception signal to the controller 230. The transmitter 222 performs various types of transmission under the control of the controller 230. The transmitter 222 transmits a transmission signal output by the controller 230 to the outside.

The controller 230 performs various types of control for the gNB 200. The controller 230 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of layers to be described below. The controller 230 may perform all of the processing and operations in the gNB 200 in each embodiment to be described below.

### Configuration of Relay Node

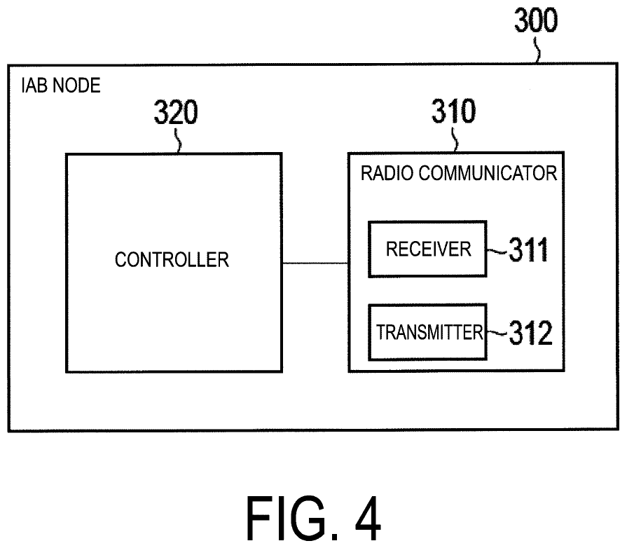

A configuration of the IAB node 300 that is a relay node (or a relay node apparatus, which may hereinafter be referred to as a “relay node”) according to the embodiment will be described. FIG. 4 is a diagram illustrating a configuration example of the IAB node 300. As illustrated in FIG. 4, the IAB node 300 includes a radio communicator 310 and a controller 320. The IAB node 300 may include a plurality of radio communicators 310.

The radio communicator 310 performs radio communication (BH link) with the gNB 200 and radio communication (access link) with the UE 100. The radio communicator 310 for BH link communication and the radio communicator 310 for access link communication may be provided separately.

The radio communicator 310 includes a receiver 311 and a transmitter 312. The receiver 311 performs various types of reception under the control of the controller 320. The receiver 311 includes an antenna, and converts (down-converts) a radio signal received by the antenna into a baseband signal (reception signal) and outputs the converted signal to the controller 320. The transmitter 312 performs various types of transmission under the control of the controller 320. The transmitter 312 includes an antenna, and converts (up-converts) a baseband signal (transmission signal) output by the controller 320 into a radio signal and transmits the converted signal from the antenna.

The controller 320 performs various types of control in the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of layers to be described below. The controller 320 may perform each process or each operation in the IAB node 300 in each embodiment to be described below.

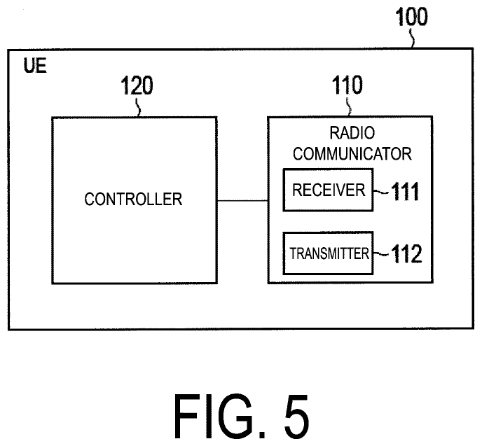

Configuration of User equipment
The configuration of the UE 100, which is a user equipment according to the embodiment, will be described. FIG. 5 is a diagram illustrating a configuration example of the UE 100. As illustrated in FIG. 5, the UE 100 includes a radio communicator 110 and a controller 120.

The radio communicator 110 performs radio communication in an access link, that is, radio communication with the gNB 200 and radio communication with the IAB node 300. The radio communicator 110 may also perform radio communication in a side link, that is, radio communication with other UEs 100. The radio communicator 110 includes a receiver 111 and a transmitter 112. The receiver 111 performs various types of reception under the control of the controller 120. The receiver 111 includes an antenna, and converts (down-converts) a radio signal received by the antenna into a baseband signal (reception signal) and outputs the converted signal to the controller 120. The transmitter 112 performs various types of transmission under the control of the controller 120. The transmitter 112 includes an antenna, and converts (up-converts) a baseband signal (transmission signal) output by the controller 120 into a radio signal and transmits the converted signal from the antenna.

The controller 120 performs various types of control in the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of layers to be described below. The controller 120 may perform each process in the UE 100 in each embodiment to be described below.

### Configuration of Protocol Stack

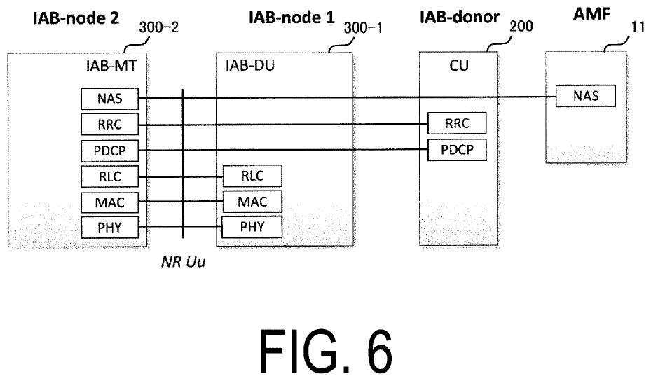

A configuration of a protocol stack according to the embodiment will be described. FIG. 6 is a diagram illustrating an example of a protocol stack related to RRC connection and NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs coding and decoding, modulation and demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing through hybrid ARQ (HARQ: Hybrid Automatic Repeat reQuest), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines a transport format (transport block size, Modulation and Coding Scheme (MCS)) and assigned resource blocks for an uplink and a downlink.

The RLC layer transmits data to the RLC layer on the reception side by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression/decompression and encryption/decryption. Data and control information are transmitted between the PDCP layer of the IAB-MT of the IAB node 300-2 and the PDCP layer of the donor node 200 via a radio bearer.

The RRC layer controls a logical channel, a transport channel, and a physical channel according to establishment, re-establishment, and release of a radio bearer. RRC signaling for various configurations is transmitted between the RRC layer of the IAB-MT of the IAB node 300-2 and the RRC layer of the donor node 200. When an RRC connection with the donor node 200 is present, the IAB-MT is in an RRC connected state. When no RRC connection with the donor node 200 is present, the IAB-MT is in an RRC idle state.

The NAS layer that is positioned upper than the RRC layer performs session management, mobility management, and the like. NAS signaling is transmitted between the NAS layer of the IAB-MT of the IAB node 300-2 and the AMF 11.

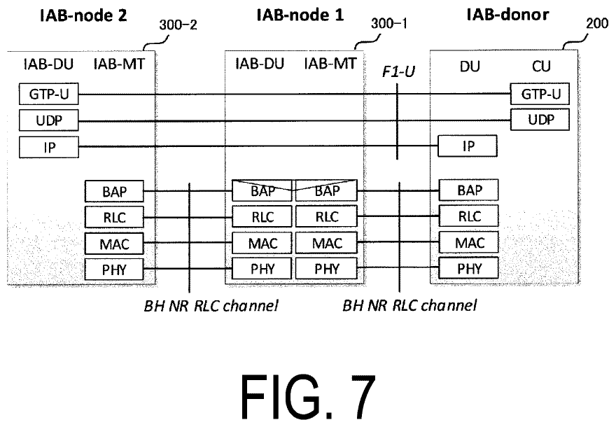

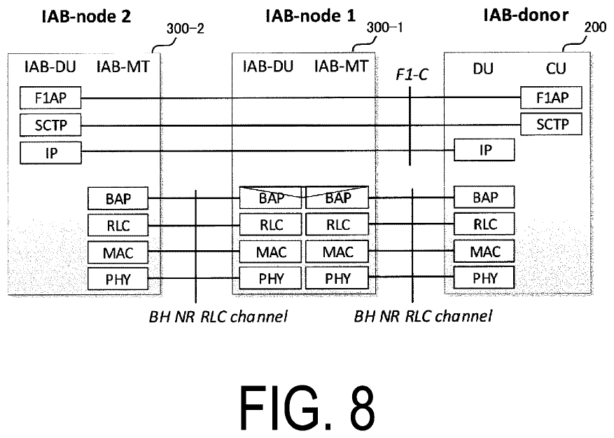

FIG. 7 is a diagram illustrating a protocol stack related to the F1-U protocol. FIG. 8 is a diagram illustrating a protocol stack related to the F1-C protocol. Here, an example in which the donor node 200 is divided into a CU and a DU is shown.

As illustrated in FIG. 7, the IAB-MT of the IAB node 300-2, the IAB-DU of the IAB node 300-1, the IAB-MT of the IAB node 300-1, and the DU of the donor node 200 each includes a Backhaul Adaptation Protocol (BAP) layer as an upper layer of the RLC layer. The BAP layer is a layer for performing a routing process and a bearer mapping/demapping process. In the backhaul, the IP layer is transmitted via the BAP layer, which allows routing by a plurality of hops.

In each backhaul link, a Protocol Data Unit (PDU) of the BAP layer is transmitted by a backhaul RLC channel (BH NR RLC channel). A plurality of backhaul RLC channels are configured in each BH link, thus enabling traffic prioritization and Quality of Service (Qos) control. The PDU of the BAP is associated with the backhaul RLC channel by the BAP layer of each IAB node 300 and the BAP layer of the donor node 200.

As illustrated in FIG. 8, the protocol stack of the F1-C protocol includes an F1AP layer and an SCTP layer instead of a GTP—U layer and an UDP layer illustrated in FIG. 7.

In the following, processes or operations performed in the IAB-DU and IAB-MT of the IAB may be simply described as processes or operations of the “IAB”. For example, the transmission of a message of the BAP layer to the IAB-MT of the IAB node 300-2 by the IAB-DU of the IAB node 300-1 will be described as the transmission of the message to the IAB node 300-2 by the IAB node 300-1. Processes or operations of the DU or CU of the donor node 200 may also be described simply as processes or operations of the “donor node”.

An upstream direction and an uplink (UL) direction may be used without distinction. A downstream direction and a downlink (DL) direction may be used without distinction.

### Mobile IAB Node

At present, 3GPP has started to study the introduction of a mobile IAB node. The mobile IAB node is, for example, a mobile IAB node. The mobile IAB node may be a movable IAB node. The mobile IAB node may be an IAB node that is capable of moving. The mobile IAB node may be an IAB node that is currently stationary but is certain to move in the future (or is expected to move in the future).

The mobile IAB node allows, for example, the UE 100 under the control of the mobile IAB node to receive services from the mobile IAB node while moving in accordance with the movement of the mobile IAB node. For example, a case is assumed in which a user (or UE 100) who is getting on a vehicle receives services via a mobile IAB node installed in the vehicle.

On the other hand, in contrast to the mobile IAB node, an IAB node that does not move also exists. Such an IAB node may be referred to as an intermediate IAB node. The intermediate IAB node is, for example, an IAB node that does not move. The intermediate IAB node may be an IAB node that is stationary. The intermediate IAB node may be a stationary IAB node. The intermediate IAB node may be an IAB node that is stationary (or does not move) in a state of being installed at its installation location. The intermediate IAB node may be a stationary IAB node that does not move. The intermediate IAB node may be a fixed IAB node.

The mobile IAB node can also be connected to the intermediate IAB node. The mobile IAB node can also be connected to the donor node 200. The mobile IAB node can also change its connection destination due to its movement (migration or handover). A connection source may be the intermediate IAB node. The connection source may be the donor node 200. The connection destination may be the intermediate IAB node. The connection destination may be the donor node 200.

In the following, the migration of the mobile IAB node and the handover of the mobile IAB node may be used without distinction.

In the following, the mobile IAB node may be a “mobile IAB node”, or may be “migrating IAB node”. In either case, the node may be referred to as a mobile IAB node.

### Full Migration of Mobile IAB Node

The mobile IAB node may move between the donor nodes (IAB-donors) 200.

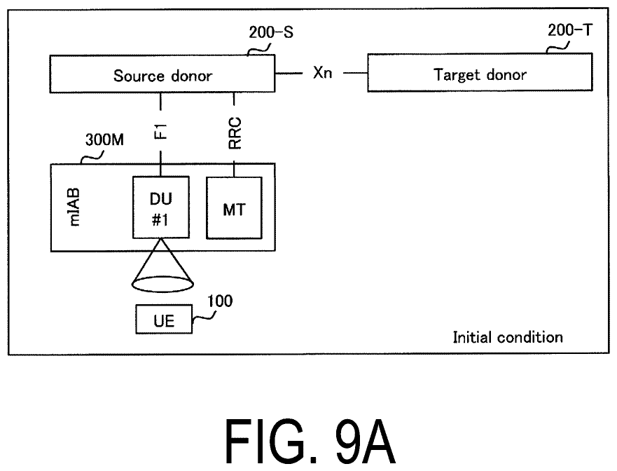

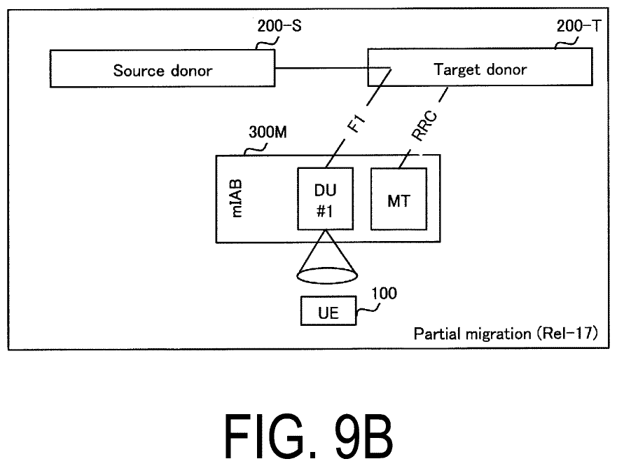

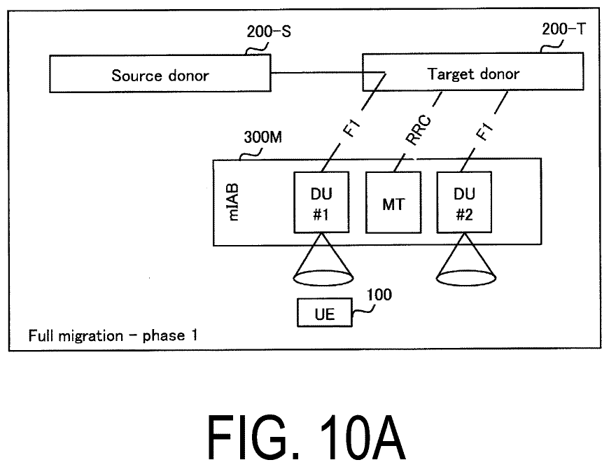

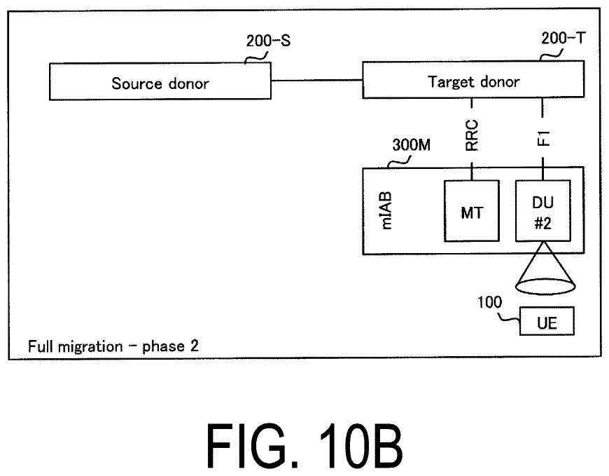

FIGS. 9A to 10B are diagrams illustrating an example of a procedure when a mobile IAB node 300M moves from a source donor node 200-S to a target donor node 200-T. The mobile IAB node 300M accommodates the UE 100 under its control. FIG. 9A illustrates an example in which the UE 100 exists in a cell range formed by an IAB-DU #1 of the mobile IAB node 300M. The UE 100 can move together with the mobile IAB node 300M.

FIG. 9A illustrates an example of an Initial condition. The IAB-DU #1 of the mobile IAB node 300M has established an F1 connection with the CU of the source donor node 200-S. The IAB-MT of the mobile IAB node 300M has also established an RRC connection with the CU of the source donor node 200-S.

FIG. 9B illustrates an example of a case where the mobile IAB node 300M has moved to the target donor node 200-T, resulting in a state of Partial migration with respect to the target donor node 200-T. As illustrated in FIG. 9B, in the partial migration, the IAB-DU #1 (and UE 100) of the mobile IAB node 300M is terminated in the CU of the source donor node 200-S, while the IAB-MT of the mobile IAB node 300M has moved to the CU of the target donor node 200-T. The IAB-MT of the mobile IAB node 300M has established an RRC connection with the CU of the target donor node 200-T. The IAB-DU of the mobile IAB node 300M has established an F1 connection with the source donor node 200-S. The partial migration refers to, for example, a state in which the connection of the UE 100 under the control of the mobile IAB node 300M remains in the source donor node 200-S via the IAB-DU #1 of the mobile IAB node 300M.

FIG. 10A illustrates an example of a case where the mobile IAB node 300M subsequently enters a state of a phase 1 of Full migration with respect to the target donor node 200-T. In the phase 1 of the full migration, the UE 100 remains connected to the source donor node 200-S via the IAB-DU #1, but a new IAB-DU #2 has established an F1 connection with the CU of the target donor node 200-T. Here, the IAB-DU #1 and the IAB-DU #2 may be logical IAB-DUs. One physical IAB-DU may include two logical IAB-DUs (IAB-DU #1 and IAB-DU #2).

FIG. 10B illustrates an example of a case where the mobile IAB node 300M subsequently enters a state of a phase 2 of full migration with respect to the target donor node 200-T. In the phase 2 of the full migration, the connection of the mobile IAB node 300M (and UE 100) has moved from the CU of the source donor node 200-S to the CU of the target donor node 200-T. The full migration refers to, for example, a state in which the connection of the UE 100 has moved to the target donor node 200-T via the IAB-DU #2 of the mobile IAB node 300M.

In addition, movement between CUs using two DUs (IAB-DU #1 and IAB-DU #2) by the mobile IAB node 300M may be referred to as “dual DU approach”. For example, the dual DU approach is performed when the UE 100 moves from one CU and DU to the other CU and DU.

### Communication Control Method According to First Embodiment

As illustrated in FIG. 10(A) and FIG. 10(B), while the mobile IAB node 300M is being completely moved, the UE 100 as a lower node of the mobile IAB node 300M performs a handover from the IAB-DU #1 to the IAB-DU #2.

In 3GPP, performing the handover as a Conditional Handover (CHO) has been discussed. To be more specific, two cases are discussed: a case where the conditional handover is performed by the mobile IAB node 300M broadcasting an execution instruction for a conditional handover and a case where a conventional conditional handover is used.

In the former case, the mobile IAB node 300M broadcasts the execution instruction for the conditional handover to the UE 100 as a lower node of the mobile IAB node 300M. Accordingly, in the former case, processing loads for signaling in a downlink direction can be reduced as compared with a case where the execution instruction is performed by dedicated signaling (for example, an RRC message). On the other hand, in the former case, since the execution instruction is broadcasted, all the UEs 100 as lower nodes of the mobile IAB node 300M may execute the conditional handover all at once. In such a case, a plurality of UEs 100 may transmit the PRACH (Msg1) all at once. Therefore, in the former case, loads may be imposed on signaling in an uplink direction.

On the other hand, also in the latter case, when a plurality of UEs 100 as a lower node of the mobile IAB node 300M satisfy a predetermined trigger condition all at once (event A3, event A4, or event A5), the plurality of UEs 100 may simultaneously transmit the PRACH. Therefore, also in the latter case, loads may be imposed on the signaling in the uplink direction.

Thus, the first embodiment aims to distribute signaling loads in the uplink direction.

Accordingly, in the first embodiment, first, the base station (for example, the gNB 200) transmits a conditional reconfiguration to the user equipment (for example, the UE 100). Second, the user equipment executes a conditional handover after a predetermined amount of time has elapsed since detection of a predetermined condition. Here, the detection of the predetermined condition is either satisfaction of a trigger condition included in the conditional reconfiguration or reception of an execution instruction for the conditional handover from the base station. The predetermined amount of time is an amount of time different for each user equipment.

As described above, in the first embodiment, the UE 100 executes the conditional handover after the elapse, since the detection of the predetermined condition, of the predetermined amount of time which is different for each UE 100. Accordingly, in the first embodiment, the execution of the conditional handover can be started, that is, the PRACH can be transmitted at a timing different for each UE 100. Therefore, in the first embodiment, the signaling loads in the uplink direction can be distributed.

Note that the “gNB 200” may hereinafter refer to the mobile IAB node 300M, a parent node of the mobile IAB node 300M, and the donor node 200 (or the gNB 200). In other words, the gNB 200 may be the mobile IAB node 300M. Alternatively, the gNB 200 may be the parent node of the mobile IAB node 300M. Alternatively, the gNB 200 may be the donor node 200.

### Operation Example According to First Embodiment

An operation example according to the first embodiment will be described.

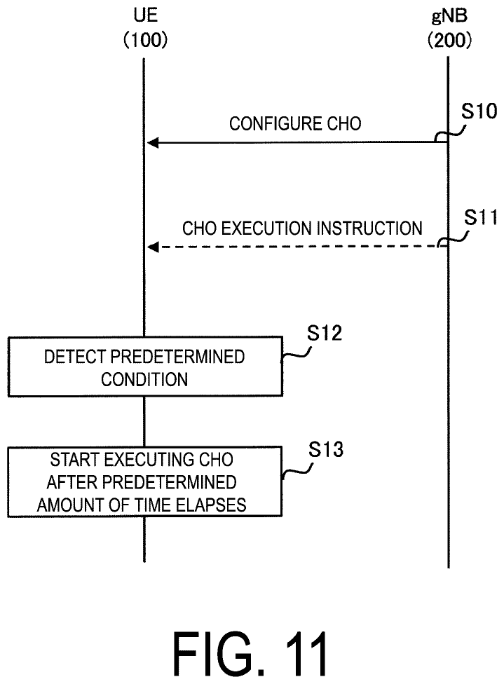

FIG. 11 is a diagram illustrating an operation example according to the first embodiment.

As illustrated in FIG. 11, in step S10, the gNB 200 (source cell) configures the conditional handover for the UE 100. The gNB 200 may perform the configuration by transmitting, to the UE 100, a conditional reconfiguration (ConditionalReconfiguration) including configuration information of the conditional handover. The gNB 200 may transmit the conditional reconfiguration to the UE 100 by using an RRC reconfiguration (RRCReconfiguration) message. The UE 100 receives the configuration of the conditional handover from the gNB 200 by the conditional reconfiguration.

First, the conditional reconfiguration includes a trigger condition used when the UE 100 executes the conditional handover. The conditional reconfiguration may include a plurality of the trigger conditions.

Second, the conditional reconfiguration may include instruction information indicating that a predetermined amount of time (or duration) is to be set side that is required from the detection of the predetermined condition to the conditional handover. Alternatively, the conditional reconfiguration may include instruction information indicating that the conditional handover is to be executed after the predetermined amount of time elapses. The predetermined condition includes satisfaction of the trigger condition included in the conditional reconfiguration. In this case, when the trigger condition is satisfied, the UE 100 executes the conditional handover after the predetermined amount of time elapses. The predetermined condition includes the reception of the execution instruction for the conditional handover broadcasted from the gNB 200. In this case, upon receiving the execution instruction, the UE 100 executes the conditional handover after the predetermined amount of time elapses.

Third, when the conditional reconfiguration includes the instruction information indicating that the predetermined amount of time is to be set aside, the conditional reconfiguration may include configuration information regarding a calculation method for the predetermined amount of time.

As the calculation method, a random number may be used. The predetermined amount of time can be made different for each piece of the UE 100 by the random number. The configuration information may include information indicating that the conditional handover is triggered when a generated random number is equal to or greater than a predetermined threshold. The random number may be generated with a certain period. The configuration information may include the certain period. The configuration information may include an upper limit value for the number of times that a random number is generated. The upper limit value may be an upper limit value for the number of times that random numbers are consecutively generated. The upper limit value may be an upper limit value for the total number of times that random numbers are generated. Alternatively, the upper limit value may be an upper limit value for the number of times that the generated random number is equal to or less than a predetermined threshold (that is, the number of times that transmission is suspended). When the number of times that random numbers are generated reaches the upper limit value (or exceeds the upper limit value), the UE 100 may execute the conditional handover without determining whether to execute the conditional handover based on the generation of random numbers. This is to enable the UE 100 to execute the conditional handover even when the number of times that the random number is less than the predetermined threshold reaches the upper limit value.

Alternatively, the calculation method may use a UE-ID. In other words, the UE 100 executes the conditional handover at a timing associated with the UE-ID. As a result, the conditional handover can be executed after a waiting time (predetermined amount of time) different for each piece of the UE 100 elapses. The UE-ID may be an International Mobile Subscriber Identity (IMSI). The UE-ID may be an 5G S-Temporary Mobile Subscriber Identity (5G-S-TMSI). For the association between the UE-ID and a subframe, the conditional handover may be executed in the subframe in which an expression (subframe number=(UE-ID) mod 10) is satisfied. The target to be associated with the UE-ID may be other than the subframe. For example, the target may be a radio frame, a combination of a radio frame and a subframe, or another timing (for example, the number of each subframe in which a PRACH resource is present).

Fourth, the conditional reconfiguration may include a predetermined amount of time. At the time of configuration for the conditional reconfiguration, a different predetermined amount of time is configured for each piece of the UE 100. The UE 100 executes the conditional handover after the predetermined amount of time has elapsed since the timing at which the predetermined condition is detected.

In step S11, the UE 100 may receive the execution instruction for the conditional handover broadcasted from the gNB 200.

In step S12, the UE 100 detects the predetermined condition. The detection of the predetermined condition is either satisfaction of the trigger condition included in the conditional reconfiguration (step S10) or reception of the execution instruction for the conditional handover.

First, the UE 100 may determine to execute the conditional handover after the predetermined amount of time has elapsed only when receiving the execution instruction for the conditional handover. In other words, in the configuration of an existing conditional handover, the UE 100 starts to execute the conditional handover when the trigger condition is satisfied (that is, an existing operation), and performs, only when receiving the execution instruction, a new operation of executing the conditional handover after the predetermined amount of time elapses.

Second, the UE 100 may determine to execute the conditional handover after the predetermined amount of time elapses when the trigger condition for the conditional handover is satisfied and the configuration of the predetermined amount of time is performed by the conditional reconfiguration.

In step S13, upon detecting the predetermined condition, the UE 100 executes the conditional handover after the predetermined amount of time has elapsed since the detection of the predetermined condition. In other words, the UE 100 starts accessing a target cell and starts transmitting the PRACH. The predetermined amount of time corresponds to a timing different for each piece of the UE 100, each piece of the UE 100 transmits the PRACH at the different timing.

### Another Operation Example of First Embodiment

In the first embodiment, an example has been described in which the UE 100 starts executing the conditional handover after the predetermined amount of time has elapsed since the detection of the predetermined condition, but the present disclosure is not limited thereto. For example, the UE 100 may start transmitting the PRACH after the predetermined amount of time has elapsed since the start of execution of the conditional handover. In other words, the UE 100 starts executing the conditional handover upon detecting the predetermined condition, and transmits the PRACH after the predetermined amount of time has elapsed since the start of the execution. Since the PRACH is transmitted at a timing different for each piece of the UE, the signaling in the uplink direction can be distributed as in the first embodiment.

### Second Embodiment

A second embodiment will be described. In the second embodiment, differences from the first embodiment will mainly be described.

The second embodiment is also an embodiment for preventing a possible collision between PRACH transmissions. Specifically, first, the base station (for example, the gNB 200) configures a PRACH resource for the user equipment (for example, the UE 100). Second, when the user equipment executes the conditional handover, the user equipment transmits the PRACH using the PRACH resource configured for the user equipment. Here, the PRACH resource is a resource different for each user equipment.

In this way, in the second embodiment, PRACH transmission can be performed using the PRACH resource different for each piece of the UE 100. Accordingly, the second embodiment can avoid a possible collision between PRACH transmissions to distribute the signaling in the uplink direction.

### Operation Example According to Second Embodiment

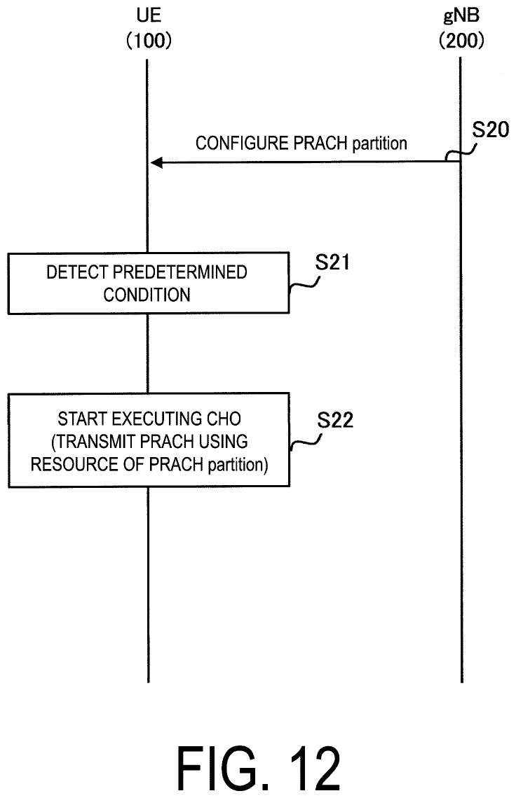

FIG. 12 is a diagram illustrating an operation example according to the second embodiment. Before the operation illustrated in FIG. 12 is started, the gNB 200 configures the UE 100 with the conditional handover (step S10 in FIG. 11).

As illustrated in FIG. 12, in step S20, the gNB 200 (source cell) configures a PRACH partition to be used for PRACH transmission when conditional handover is executed. For example, the gNB 200 may broadcast the PRACH partition using broadcast signaling (for example, a system information block (SIB)). The gNB 200 may transmit the PRACH partition to the UE 100 by using individual signaling (for example, an RRC message). The PRACH partition may be configured in the configuration of the conditional handover (step S10 in FIG. 11).

For example, the PRACH partition is obtained by dividing all resources used for PRACH transmission into PRACH partitions for respective predetermined ranges. The PRACH partition may be assigned for each group of UEs 100. The PRACH partition may include a configuration of PRACH resources available to the UE 100. The PRACH partition may include a partition ID (partition identification information) allocated to each partition. In this case, the PRACH resource itself may be broadcast from the target cell of the conditional handover by using the SIB. Note that the conditional reconfiguration (step S10 in FIG. 11) may include instruction information indicating whether to use the PRACH partition.

In step S21, the UE 100 detects the predetermined condition. As in the first embodiment, the detection of the predetermined condition may be satisfaction of the trigger condition included in the conditional reconfiguration. The detection of the predetermined condition may be reception of the execution instruction for the conditional handover broadcasted from the gNB 200. The execution instruction may include instruction information indicating whether to use the PRACH partition.

In step S22, upon detecting the predetermined condition, the UE 100 starts executing the conditional handover. When executing the conditional handover, the UE 100 transmits the PRACH by using the PRACH resource configured for the UE 100.

In this way, the resource configured by the PRACH partition is a resource different for each group of UEs 100 (or for each UE 100), a possible collision between PRACH transmission can be avoided, and the signaling in the uplink direction can be distributed.

### Third Embodiment

A third embodiment will be described. Also in the third embodiment, differences from the first embodiment will mainly be described.

The third embodiment is an embodiment in which PRACH transmissions are distributed in a spatial direction. To be more specific, first, the base station (for example, the gNB 200) transmits, to the user equipment (for example, the UE 100), a conditional reconfiguration including beam information representing a beam to be used by the user equipment. Second, when executing the conditional handover, the user equipment transmits the PRACH using a resource associated with the beam. Here, the beam is a beam different for each user equipment.

As described above, in the third embodiment, the gNB 200 assigns a different beam to each UE 100, and the UE 100 transmits the PRACH by using the resource associated with the beam. Accordingly, since the PRACH is transmitted using the resource different for each piece of the UE, the signaling in the uplink direction can be distributed.

### Operation Example According to Third Embodiment

An operation example according to the third embodiment will be described.

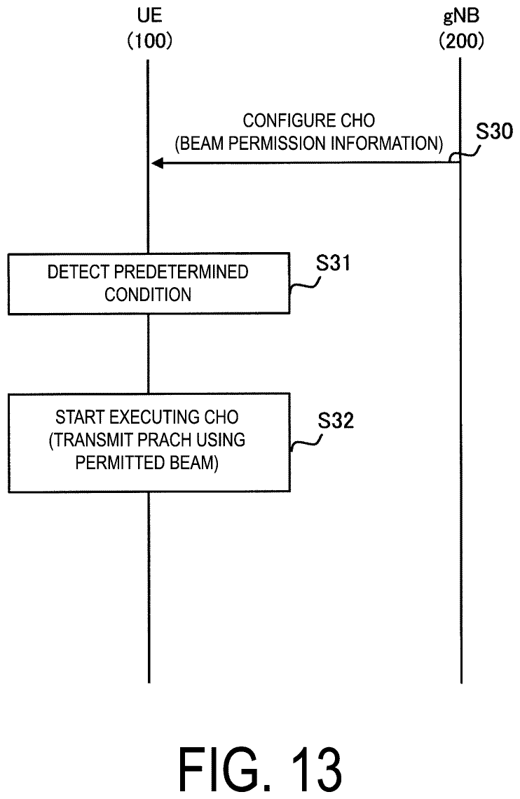

FIG. 13 is a diagram illustrating an operation example according to the third embodiment.

As illustrated in FIG. 13, in step 30, the gNB 200 (source cell) configures the conditional handover for the UE 100. As in the first embodiment, the gNB 200 performs the configuration by transmitting the conditional reconfiguration to the UE 100. The conditional reconfiguration may include beam information. The beam information represents a beam of the target cell to be used (or permitted to be used) by the UE 100 for PRACH transmission. The gNB 200 transmits beams in different directions at different timings by beam sweeping, and the UE 100 performs PRACH transmission using an optimal beam. The beam information represents, for example, information of the beam to be used by the UE 100 among a plurality of beams. The beam information may represent a beam different for each piece of the UE 100. The beam information may represent a beam different for each group of UEs 100. The beam information may be represented by an index of the beam. Alternatively, the beam information may be represented by an index of a Synchronization Signal Block (SSB).

In step S31, the UE 100 detects the predetermined condition. As in the first embodiment, the detection of the predetermined condition may be satisfaction of the trigger condition included in the conditional reconfiguration. The detection of the predetermined condition may be reception of the execution instruction for the conditional handover broadcasted from the gNB 200. The execution instruction may include the beam information.

In step S32, upon detecting the predetermined condition, the UE 100 starts executing the conditional handover, and transmits the PRACH using a resource associated with the beam represented by the beam information.

Note that while the UE 100 is executing the conditional handover after transmitting the PRACH, the gNB 200 may direct all beams in the same direction without performing beam sweeping. This is to avoid a situation in which the UE 100 fails to receive the beam configured by the beam information while the conditional handover is in execution.

### Fourth Embodiment

A fourth embodiment will be described. Also in the fourth embodiment, differences from the first embodiment will mainly be described.

In the third embodiment, an example has been described in which information of the beam to be used by the UE 100 is explicitly indicated as beam information. In the fourth embodiment, an example will be described in which the beam to be used for access to the target cell is specified instead of being explicitly indicated by the beam information.

To be more specific, first, the base station (for example, the mobile IAB node 300M) controls the beam directions of the target cell and the source cell in such a manner that the beams of the target cell and the source cell are pointed in the same direction at the same timing. Second, the user equipment (for example, the UE 100) transmits the PRACH to the target cell by using a resource associated with the same beam as that used in the source cell.

For example, in full migration illustrated in FIG. 10(A), the UE 100 performs a handover from IAB-DU #1 to IAB-DU #2 of the mobile IAB node 300M. Although the UE 100 as a lower node of the mobile IAB node 300M does not actually migrate with respect to the mobile IAB node 300M, the handover may be performed. In such a case, the mobile IAB node 300M controls the beam of the source cell formed by the IAB-DU #1 and the beam of the target cell formed by the IAB-DU #2 in such a manner that the beams are pointed in the same direction at the same timing (or the beams are the same in beam index and beam direction (weight)). Then, the UE 100 starts executing the conditional handover, and transmits the PRACH to the target cell by using a resource associated with the same beam as that used in the source cell.

### Operation Example According to Fourth Embodiment

An operation example according to the fourth embodiment will be described. Note that, in the following description, the gNB 200 is assumed to be the mobile IAB node 300M and the UE 100 is assumed to be UE as a lower node of the mobile IAB node 300M.

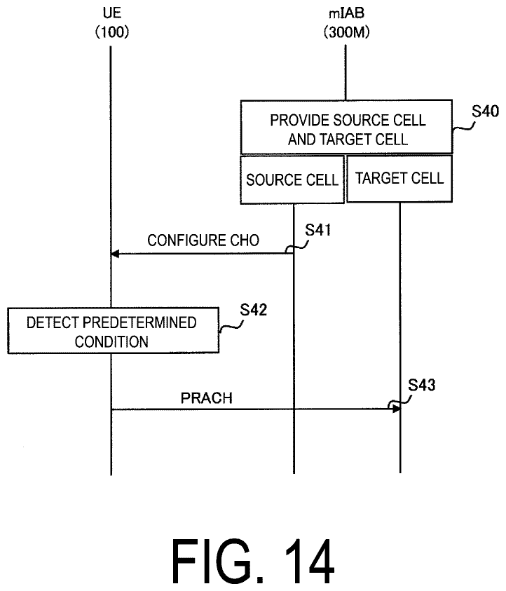

FIG. 14 is a diagram illustrating an operation example according to the fourth embodiment.

As illustrated in FIG. 14, in step S40, the mobile IAB node (mIAB) 300M provides a source cell and a target cell. The UE 100 performs a conditional handover from the source cell to the target cell. Here, the mobile IAB node 300M performs control of coordinating the beam of the source cell with the beam of the target cell. In other words, the mobile IAB node 300M matches the weight (beam direction or pointing direction) for each beam index (or each SSB) between the source cell and the target cell. For example, the beam with beam index #1 points in the same direction between the source cell and the target cell, and the like. Accordingly, for example, beams are formed that are pointed in the same direction (or provide the same coverage) at the same timing between the source cell and the target cell.

In step S41, the source cell transmits the conditional reconfiguration to the UE 100. The conditional reconfiguration may include instruction information indicating that the beam index currently in use is to be used to access the target cell.

In step S42, the UE 100 detects the predetermined condition. As in the first embodiment, the detection of the predetermined condition is either the satisfaction of the trigger condition included in the conditional reconfiguration or the reception of the execution instruction for the conditional handover from the mobile IAB node 300M. The execution instruction may include instruction information indicating that the beam index currently in use is to be used to access the target cell.

In step S43, the UE 100 transmits the PRACH to the target cell upon detecting the predetermined condition. To be more specific, the UE 100 transmits the PRACH to the target cell by using a resource associated with the same beam as that of the beam index used in the source cell.

### Fifth Embodiment

A fifth embodiment will be described. In the fifth embodiment, differences from the first embodiment will mainly be described.

The first to fourth embodiments mainly describes the avoidance of a possible collision between PRACH transmissions when the conditional handover is executed.

In other words, in the first to the fourth embodiment, the avoidance of a possible collision between PRACH (Msg1) transmissions has been described, the collision being caused by the all-at-once reception of the execution instruction for the conditional handover or the simultaneous satisfaction of the trigger condition for the conditional handover by a plurality of UEs 100.

However, even when the collision between PRACH (Msg1) transmissions can be avoided, transmissions of an RRC reconfiguration complete (RRCReconfigurationComplete) message (Msg3) may collide.

Thus, in the fifth embodiment, an example will be described in which the gNB 200 adjusts the transmission timing of a Random Access Response (Msg2) for each UE 100.

To be more specific, first, the user equipment (for example, the UE 100) transmits the PRACH (Msg1) to the target cell when executing a conditional handover. Second, the target cell transmits the random access response (Msg2) to the user equipment at a timing different for each user equipment. Third, the user equipment transmits an RRC reconfiguration complete message (Msg3) to the target cell at a timing different for each user equipment.

In this way, for example, since the UE 100 receives the random access response (Msg2) at the timing different for each UE 100, the UE 100 can transmit the RRC reconfiguration complete message (Msg3) at the timing different for each UE 100. Therefore, a possible collision between transmissions of the RRC reconfiguration complete message can be suppressed, and the signaling in the uplink direction can be distributed.

### Operation Example According to Fifth Embodiment

An operation example according to the fifth embodiment will be described.

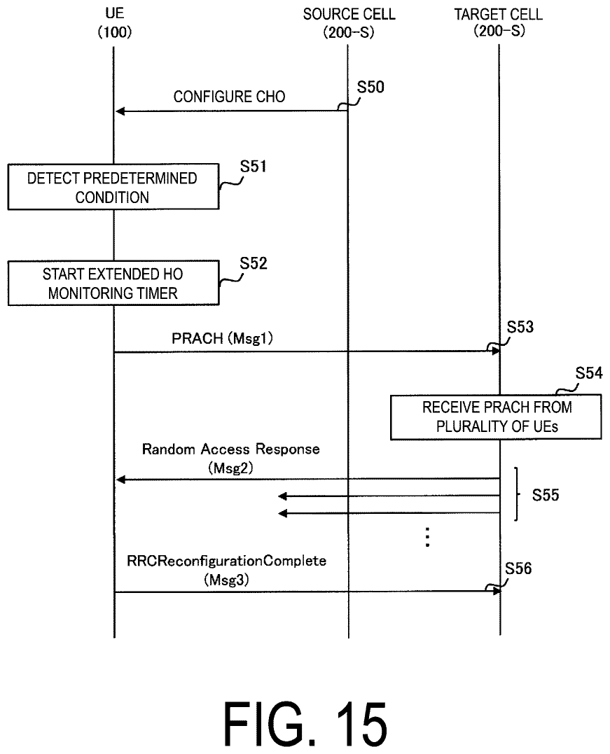

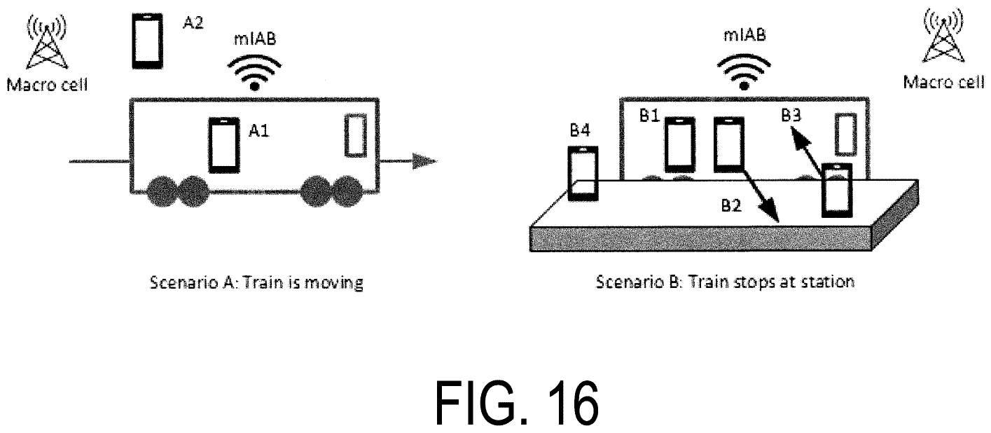

FIG. 15 is a flowchart illustrating an operation example according to the fifth embodiment. The source cell and the target cell may belong to the same gNB 200 or to different gNB 200.

As illustrated in FIG. 15, in step S50, the source cell transmits the conditional reconfiguration to the UE 100. The conditional reconfiguration may include a configuration value of an extended handover monitoring timer (or an extended monitoring timer) instead of a T304 timer. When the transmission timing of the random access response (Msg2) is shifted for each UE 100, the transmission timing of the RRC reconfiguration complete message (Msg3) may be delayed compared to the transmission timing in the related art. The delay may increase the count value of the T304 timer beyond a predetermined value (that is, the T304 timer expires), and the UE 100 may not be able to transmit the RRC reconfiguration complete message (Msg3). Thus, the extended handover monitoring timer enables the UE 100 to transmit the RRC reconfiguration complete message (Msg3) even when the reception of the random access response (Msg) is delayed compared to the reception in the related art. Note that, instead of transmitting the conditional reconfiguration, the source cell may transmit, to the UE 100, a handover command (for example, an RRC reconfiguration with synchronization (RRCReconfiguration with sync) message) instructing a handover.

In step S51, when the conditional reconfiguration is performed, the UE 100 detects the predetermined condition. As in the first embodiment, the predetermined condition is either the satisfaction of the trigger condition included in the conditional reconfiguration or the reception of the execution instruction for the conditional handover from the gNB 200. The execution instruction may include a timer value (or an expiry value) of the extended handover monitoring timer or an instruction to use the timer.

Then, the UE 100 starts access to the target cell. In other words, in step S52, the UE 100 starts counting with the extended handover monitoring timer. The UE 100 may start counting with the timer upon starting access to the target cell.

In step S53, the UE 100 transmits the PRACH (Msg1) to the target cell.

In step S54, the target cell receives PRACH from a plurality of UEs 100.

In step S55, the target cell transmits the random access response (Msg2) to the UE 100 at a different timing for each UE 100 (or for each group of UEs 100).

In step S56, in response to receiving the random access response (Msg3), the UE 100 transmits the RRC reconfiguration complete message (Msg2) to the target cell. Since the UE 100 receives the random access response at the timing different for each UE 100, the UE 100 transmits the RRC reconfiguration complete message (Msg3) at a timing different for each UE.

Note that when the UE 100 fails to transmit the RRC reconfiguration complete message (Msg3) even though the count value of the extended handover monitoring timer reaches the timer value (or the expiry value) (that is, even though the timer expires), the UE 100 determines that the conditional handover has failed. In this case, the UE 100 may transition to the RRC idle state.

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not need to be executed, and only some of the steps may be executed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

Although the term “network node” mainly refers to a base station, it may also refer to an apparatus of a core network or a part (CU, DU or RU) of a base station. The network node may include a combination of at least a part of the apparatus of the core network and at least a part of the base station.

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing processing performed by the UE 100 or the gNB 200 may be integrated, and at least a part of the UE 100 and the gNB 200 may be implemented as a semiconductor integrated circuit (chipset, System on a chip (SoC)).

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. The embodiments, the operation examples, or the different types of processing may be combined as appropriate as long as they are not inconsistent with each other.

### First Supplementary Notes

### Supplementary Note 1

A communication control method used in a cellular communication system, the communication control method including the steps of:
transmitting, by a network node, a conditional reconfiguration to user equipments; and
executing, by each of the user equipments, a conditional handover after a predetermined amount of time has elapsed since detection of a predetermined condition, in which
the detection of the predetermined condition is either satisfaction of a trigger condition included in the conditional reconfiguration or reception of an execution instruction for the conditional handover from the network node, and
the predetermined amount of time is an amount of time different for each of the user equipments.

### Supplementary Note 2

The communication control method according to Supplementary Note 1, in which the conditional reconfiguration includes instruction information instructing that the predetermined amount of time from the detection of the predetermined condition to execution of the conditional handover is to be set aside.

### Supplementary Note 3

The communication control method according to Supplementary Note 1 or Supplementary Note 2, in which the conditional reconfiguration includes the predetermined amount of time.

### Supplementary Note 4

A communication control method used in a cellular communication system, the communication control method including the steps of:
configuring, by a network node, PRACH resources for user equipments; and
transmitting, by a user equipment of the user equipments, a PRACH by using a PRACH resource of the PRACH resources configured for the user equipment when executing a conditional handover, in which
the PRACH resource is a resource different for each of the user equipments.

### Supplementary Note 5

The communication control method according to any one of Supplementary Notes 1 to 4, in which
the transmitting includes executing, by the user equipment, the conditional handover upon detecting a predetermined condition, and
the detection of the predetermined condition is either satisfaction of a trigger condition included in a conditional reconfiguration received from the network node or reception of an execution instruction for the conditional handover from the network node.

### Supplementary Note 6

The communication control method according to any one of Supplementary Notes 1 to 5, in which
the execution instruction includes instruction information indicating instruction whether to use the PRACH resource.

### Supplementary Note 7

A communication control method used in a cellular communication system, the communication control method including the steps of:
transmitting, to user equipments by a network node, a conditional reconfiguration including beam information representing a beam to be used by a user equipment of the user equipments; and
transmitting, by the user equipment, a PRACH by using a resource associated with the beam when executing a conditional handover, in which
the beam is a beam different for each of the user equipments.

### Supplementary Note 8

The communication control method according to any one of Supplementary Notes 1 to 7, further including
controlling, by the network node, beam directions of a target cell and a source cell in such a manner that a beam of the target cell and a beam of the source cell are pointed in the same direction at the same timing, in which
the transmitting by the user equipment includes transmitting, by the user equipment, the PRACH to the target cell by using the resource associated with the same beam as the beam used in the source cell.

### Supplementary Note 9

A communication control method used in a cellular communication system, the communication control method including the steps of:
transmitting, by user equipments, PRACHs (Msgls) to a target cell when each of the user equipments executes a conditional handover;
transmitting, by the target cell, random access responses (Msg2s) to the user equipments at timings different for each of the user equipments; and
transmitting, by the user equipments, RRC reconfiguration complete (RRCReconfigurationComplete) messages (Msg3s) to the target cell at timings different for each of the user equipments.

### Supplementary Note 10

The communication control method according to any one of Supplementary Notes 1 to 9, further including:
transmitting, to a user equipment of the user equipments by a source cell, a conditional reconfiguration including an extended monitoring timer, in which
the transmitting the PRACHs (Msg1s) includes starting counting the extended monitoring timer when the user equipment starts access to the target cell, and
the transmitting the RRC reconfiguration complete messages (Msg3s) includes determining that the conditional handover has failed when the user equipment fails to transmit an RRC reconfiguration complete message (Msg3) of the RRC reconfiguration complete messages (Msg3s) even after a count value of the extended monitoring timer reaches an expiry value.

### Second Supplementary Notes

### Introduction

The WID related to a mobile IAB was revised in the RAN #97e with the following objectives. The detailed objectives of WI are as follows.
A mobility/topology adaptation procedure for realizing mobility of an IAB node is defined, including inter-donor migration (full migration) of the entire mobile IAB node.
The mobile IAB node can connect to a fixed (intermediate) IAB node. No priority is given to optimization specific to a scenario where the mobile IAB node is connected to the stationary (intermediate) IAB node or is directly connected to an IAB donor DU.
Mobility of a dual-connected IAB node is deprioritized.
The mobility of the IAB node and a UE receiving a service of the IAB node is enhanced, including aspects related to group mobility. There is no optimization related to targeting of neighboring UEs.
   Note: Solutions should avoid touching on topics already discussed in the Rel-17 or topics excluded from the Rel-17, except for IAB node mobility-specific enhancements.
Mitigation of interference due to IAB node mobility, including avoidance of a potential collision between reference signal and control signal (PCI, RACH, and the like).

The following principles should be respected:
The mobile IAB node should be able to provide a service to a legacy UE.
There is a possibility that solutions providing optimization for the mobile IAB may involve enhancements to the Rel-18 UE.

One of main problems in the Rel-18 is how to efficiently execute handovers of a plurality of descendant UEs during movement between mobile IAB nodes. In these appendices, details of mobility enhancement for a mobile IAB are described.

### Discussion

### Enhanced UE Mobility

### Handover Procedure of UE

The RAN2 #119bis-e has reached the following agreement in regard to a handover procedure of the UE.
The RAN2 focuses on a scenario in which during full migration, the UE recognizes two logical DU cells as different physical cells (for example, the same carriers have different PCIs) and the two logical DU cells use separate physical resources (that is, time-frequency resources in which different carriers or the same carriers are orthogonal to one another as supported in legacy L1). From QC tdoc, the following options O1, O2, and O3 are taken into account.
1) Suspension of a message by the logical source IAB-DU
2) Conditional execution by the UE (including a CHO with a new trigger) based on broadcast indication, for example, SIB indication of a service time or DCI indication of MT migration
3) Legacy CHO (including implementation specific operations such as the use of source cell power down and target cell power up for triggering an actual HO) The RAN2 assumes that O1 and O3 described above are functional, and further studies are needed when O2 described above (the new trigger and the like) is required.

O1, involving the suspended delivery, operates with Rel-15 UEs and is thus considered as a baseline. O3 with the current conditional handover (CHO) operates with Rel-16 UEs. Therefore, whether to enhance the CHO for the Rel-18, such as by basing the CHO on O3, requires further studies.

There are already viable solutions, such as O1 and O3, and thus whether enhancement is really needed is questionable. On the other hand, Rel-18 UEs are assumed to occupy the majority of the network at some point in the future. In this case, if the existing solutions have any disadvantages, providing some enhancements for the Rel-18 and beyond UEs is useful. When a new solution is discussed, one of the important points is to prevent the UE handover from generating a signaling storm, as pointed out in the RAN2 #119bis-e.

Proposal 1: The RAN2 should discuss whether there is a problem with the existing solutions for the UE handover, i.e., the suspended delivery (O1) and the CHO (O3).

In case of O1, the RRC reconfiguration with synchronization is suspended by the mobile IAB node and delivered to the UE when the mobile IAB-MT has completed migration to the target donor. The mobile IAB node can manage the transmission timing of the RRC reconfiguration message, and thus the reception timing of the RRC reconfiguration complete message can be controlled. This depends on the amount of time during which the two cells (in other words, the cells are provided by the dual DU) are maintained, but during the period, a portion of DL loads may occur in the source cell and a portion of UL loads may occur in the target cell.

In case of O3, the RRC reconfiguration including the conditional reconfiguration is transmitted in advance by the IAB donor through the mobile IAB node. This enables advance preparation of the UE handover command, allowing the DL loads to be distributed in time in the source cell. On the other hand, the CHO is executed when an existing event (i.e., A3/A5) is satisfied. O3 depends on the radio condition of the source/target cell (i.e. control of transmit power), and thus, the target cell may cause a UL signaling storm, i.e. PRACH and RRC reconfiguration completion, especially when the source and target cells are provided by physically quasi-common antennas.

Based on the above-described observation, O1 may need to maintain the source cell and the target cell for a long time to reduce the DL/UL loads. O3 may cause a UL signaling storm in the target cell. In other words, the signaling storm can be avoided by maintaining the two cells (provided by the dual DU) for a minimum period of time.

Proposal 2: When the CHO is enhanced for Rel-18 UEs, the RAN2 should agree on a solution that avoids a signaling storm in the DL (source cell) and UL (target cell) even when the source and target cells are held for the minimum period of time during the migration of the mobile IAB node.

### Enhancement of Cell Reselection Function of UE

The RAN2 #119bis-e has agreed on the following confirmations, observations, and assumptions.
The RAN2 has confirmed that the mobile IAB needs to coordinate with legacy UEs.
The RAN2 has confirmed that when camping on/connecting to a mobile IAB cell for an extended period of time, the UE may consider itself to be on board the mobile IAB cell (in other words, the UE needs to know that the cell is such a cell). The time needs to be further studied. The RAN2 makes the following assumptions for the UE operating in the mobile IAB cell.
Assumption 1: From a viewpoint of the NW for the mobile IAB cell, no change is made to the configuration principle of legacy parameters (including cell (re) selection, cell reservation and access restriction) for the legacy IAB cell.
Assumption 2: There is no specification impact on the operations of legacy UEs.
Assumption 3: The information of the mobile IAB cell newly broadcast by the R18 (if agreed) does not prohibit/control access from legacy UEs.
Assumption 4: Non-enhancement-capable UEs (including legacy UEs and non-enhancement-capable R18 UEs) only ignore the information of the mobile IAB cell newly broadcast by the R18 (if agreed).
RAN2 assumption: The broadcast information of the mobile IAB cell
To assist mobility in an idle/inactive mode of the Rel-18 UE, a 1-bit mobile IAB cell type indication is introduced (further studies are needed when the UE needs to know that the UE is on board the mobile IAB cell).
How the indication is to be used needs to be further studied (this may vary depending on the implementation).
From a viewpoint of mobile IAB WI, the RAN2 has specified no modifications for preventing surrounding UEs from accessing the mobile IAB node. However, the RAN2 considers that the SA2 may be working on applicable Rel-18 solutions.

Two main scenarios and certain subcases involving expected operations of the UE can be considered as follows.
Scenario A: The mobile IAB node is migrating together with a camped UE.
Subcase A1: The UE (on a train or the like) needs to stay on the mobile IAB node.
Subcase A2: Surrounding UEs (outside the train or the like) should not camp on the mobile IAB node.
Scenario B: The mobile IAB node is at a stop together with the camped UE.
Subcase B1: The UE (for example, still on the train) should stay on the mobile IAB node.
Subcase B2: The UE (for example, getting off the train) reselects a stationary cell (for example, a macro cell).
Subcase B3: The surrounding UEs (for example, getting on the train) need to reselect the mobile IAB node.
Subcase B4: The surrounding UEs (for example, still at the station) should stay on the fixed cell.

In a subcase A1, UE moves together with a mobile IAB node. For this reason, RSRP and RSRQ from the mobile IAB node are always stable and sufficiently good. This does not trigger a cell reselection procedure. To be exact, when the frequency priority of the mobile IAB node is higher than that of the external cells, the UE may not perform intra-frequency or inter-frequency measurements. For example, the mobile IAB node broadcasts the frequency priority of the mobile IAB node as “7” or broadcasts the cell of the mobile IAB node as an HSDN cell.

The train includes a plurality of vehicles and the mobile IAB node may be deployed in each vehicle. Even when the UE moves between the vehicles, one of the mobile IAB node cells is always more stable than the external macro cell from a perspective of the UE in the train. As a typical case, the mobile IAB node cells are assumed to operate on the same frequency. In this case, the existing intra-frequency cell reselection, that is, R-criterion, functions appropriately.

Observation 1: In a typical configuration, the migrating mobile IAB cell may broadcast a serving frequency priority of “7” or an HSDN cell indication in such a manner that the UE migrating with the mobile IAB cell does not undergo cell reselection.

In the subcases B1 and B2, there is no way for the A5 to know whether the user will stay on the train or leave the train. In this case, even when the mobile IAB node broadcasts some information, the UE fails to determine which cell (mobile IAB node or fixed macro cell) should be reselected finally. For this reason, which cell the UE should reselect finally depends on the radio condition and the frequency priority. Therefore, the mobile IAB node needs to return the priority of the serving frequency configured as Observation 1. In other words, the mobile IAB node broadcasts the priority of the serving frequency, for example as is the case with the fixed macro cell layer, or stops broadcasting the HSDN cell indication.

Observation 2: When the UE and the mobile IAB node are stopped, the UE fails to determine whether to reselect the mobile IAB node unless the UE recognizes the intention of the user. In other words, this depends on the radio condition.

Observation 3: As in a typical configuration, the mobile IAB cell in the stationary state recovers the frequency priority or HSDN cell indication used by the mobile IAB cell during migration (in other words, this is similar to Observation 1).

However, in light of the above-described observation results, a drawback of the current mechanism is that the SIB of the mobile IAB node needs to be changed depending on the mobility state. However, this may not be a significant problem to be solved.

Observation 4: A drawback of the current mechanism is that the mobile IAB cell needs to change the SIB depending on the mobility state. In other words, Observation 4 is between Observations 1 and 3.

For the subcase A2, the UE can camp on a stationary macro cell with the same reasoning as in Observation 1. In other words, the UE does not perform intra-frequency measurements when the RSRP/RSRQ from the macro cell is sufficient, nor does the UE perform inter-frequency measurements when the priority of the macro cell frequency is higher than that of the mobile IAB node, or when the mobile IAB node broadcasts the HSDN cell indication (when the UE is not in a high mobility state).

For the subcases B3 and B4, for the same reasons as in Observation 2, cell reselection should depend on the radio condition, and the typical configuration of the mobile IAB node in the stationary state as in Observation 3 is also applicable.

However, the subcases A2, B3, and B4 are actions desirable for the surrounding UEs. The WID specifies that no optimization for targeting the surrounding UEs is performed. For the subcase B3, after getting on the train, the UE enters the subcase B1 or B2, but the initial state of the UE remains in the state of the surrounding UE. Therefore, these subcases are uncovered by the Rel-18.
Mobility of the IAB node and the UE thereof is enhanced, including aspects related to group mobility. No optimization for targeting surrounding UEs is performed.

Observation 5: Optimization of targeting of the surrounding UEs is outside the scope of the WI, but the same configuration as that in Observation 1 and Observation 3 may be applicable.

In summary, the existing cell reselection mechanism, that is, a cell reselection mechanism based on a radio condition and a frequency priority, still functions well. For this reason, no enhancement is required for the UE to execute cell reselection.

The HSDN is valid for the subcase A1.

Proposal 3: The RAN2 should agree that no enhancement is required for the UE to execute cell reselection for the mobile IAB node, in other words, the assumption is recovered that was made in regard to the “1-bit mobile IAB cell type indication” in the last conference.

### RACH-Less Handover for Rel-18 UE

The RAN2 #119e has reached the following agreement.
The R2 assumes that there is a possibility that an RACH-less procedure may be considered for an on-board RRC connected UE handed over with the mobile IAB node (this also depends on assumption of UL synchronization).

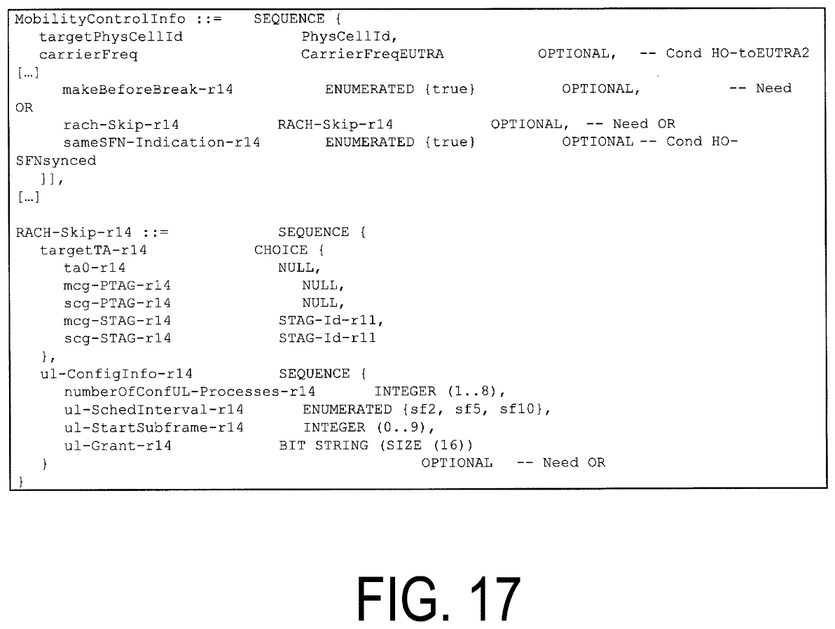

In the LTE, an RACH-less handover is configured as illustrated in FIG. 17 by using applicable timing advance (TA) and uplink grant information in MobilityControlInfo.

Regarding a TA value for the UE in the RACH-less handover during IAB node migration, the source cell and the target cell are provided via the same “physical” DU (however, the source cell and the target cell as provided via two “logical” DUs), and thus the UE is considered to apply the latest TA value in order to access the target cell. In other words, “physical” distances from the UEs should be the same. Accordingly, no explicit TA value needs to be configured for the UE. On the other hand, when an RACH-less handover is used for other scenarios, for example, a mobile IAB-MT handover, a generic approach like the LTE configuration is required.

Proposal 4: The RAN2 should discuss whether the UE should implicitly apply the latest TA value or explicitly configure the corresponding TA value for the RACH-less handover of the UE.

The UE needs to transmit RRC Reconfiguration Complete in UL resources given by the target cell, and thus UL grant information needs to be configured in the UE.

Proposal 5: The RAN2 should agree for the RACH-less handover of the UE that UL grant information is configured by a target IAB donor CU.

Considering an RRC IE structure of NR, an RACH-less configuration can be assumed to be included in reconfigurationWithSync in CellGroupConfig because the RACH-less handover is indicated by the target IAB donor CU during a handover procedure.

Proposal 6: The RAN2 should agree that the RACH-less handover is configured with a handover command (reconfiguration with synchronization).

One question is whether the RACH-less handover is also applicable to a conditional handover. The RAN2 #119e agreed that it would be useful to support a conditional RACH-less handover because “R2 assumes that a CHO or a delayed RRC configuration can be the baseline for group mobility”.

Proposal 7: The RAN2 should discuss whether the RACH-less handover can also be configured with a conditional handover (conditional reconfiguration).

### Enhancement of IAB-MT Mobility

### Indication of the Mobile IAB Node to the IAB Donor CU

In the RAN3 #117e, the following agreement was made.
The donor CU should know that the IAB node is “mobile”.

The RAN2 #119bis-e has agreed on the following baseline.

UE capability signalling is a baseline for informing the CU that the MT is of the “mobile IAB” type. Early mobile IAB indication in Msg5 or the like requires further studies.
With respect to the mobility state/mode indication, the R2 has seen that legacy reports of the mobility state (such as mobilityState-r16) may be reused and that current location reports from the UE may also be reused. Further studies are required as to whether any of these needs to be enhanced or supplemented, such as for the potential purpose of predictive mobility.

In the Rel-16 IAB, an IAB Node Indication is transmitted via a Msg5, which is intended for use by a donor to select an AMF that supports an IAB. Thus, one of the points is whether to transmit the mobile IAB node indication via the Msg5 depending on whether the donor needs to select the AMF supporting the mobile IAB. This is up to the RAN3.

In discussion on e-mails, a plurality of companies pointed out that the donor CU can acquire a real-time mobility state through the existing measurement report such as Immediate MDT. Such mobility state information is considered to be useful for predictive mobility control. A reporter clarified that the mobile IAB node indication is necessary for the donor to configure the mobile IAB node with appropriate measurement configurations. However, no serious problem is posed when the donor CU configures the mobile IAB node after receiving the UE capability signaling, and thus performing the early indication is not justified.

Therefore, whether the early mobile IAB indication is required is up to the RAN3.

Observation 6: For example, whether the early mobile IAB indication in the Msg5 is required is up to the RAN3 depending on whether the donor CU needs to select the AMF supporting the mobile IAB.

### Access Restriction of Mobile IAB Node

In the WID, mobile IAB nodes provide services only to UEs.
The mobile IAB nodes do not have descendant IAB nodes and provide services only to UEs.

To achieve requirements, the RAN2 #119e has agreed as follows.

A method of not broadcasting the “iab-Support” indication is sufficient to prevent other IAB nodes from accessing the mobile IAB (without further influence on the specifications).

However, the agreement was reached without sufficient discussion. In particular, for the portion “(without further influence on the specifications)”, whether the determination of the need may be left to implementation is questionable. The WID clearly requires the mobile IAB node to be prevented from accessing other mobile IAB nodes, and thus the specifications may need to clarify the above-described assumption in order to avoid confusion in mobile IAB implementations. For this reason, the Stage-2 specifications desirably incorporate the agreement or clarify that “in this release, the mobile IAB node cannot access other mobile IAB nodes”

Proposal 8: The RAN2 should agree to include, in the Stage-2 specifications, not configuring an IAB-Support IE in the SIB when the IAB node operates as a mobile IAB node in the present release.

Another restriction was discussed in the RAN2 #119bis-e and determined to be further studied as follows.

Further studies are required for the case of introduction of broadcasting, by a fixed network, of the indication that “mobile IAB is supported” (which is intended for mobile IAB MT).

A plurality of companies have pointed out that “whether an indication from the network to the mobile IAB node is required may depend on whether the mobile IAB node can camp on/connect to a regular IAB-capable cell”. Assuming that a legacy IAB donor is present in the network, three releases of IAB are present and different mobility mechanisms are supported according to the release. In other words, the Rel-16 supports intra-CU topology adaptation, the Rel-17 supports inter-CU topology adaptation with partial migration, and the Rel-18 supports inter-CU movement with full migration.

In other words, technically, a mobile IAB node can connect to a Rel-16 donor when the mobile IAB node only migrates close to the Rel-16 donor (i.e., within a cell belonging to the same donor CU). On the other hand, when migrating away, the mobile IAB node needs to connect to a Rel-17 or Rel-18 donor (i.e. connection between cells belonging to different donor CUs). In other words, the formerly mobile IAB node can be viewed as a stationary IAB node from a functional point of view.

Observation 7: The mobile IAB node can connect to the Rel-16 donor when migrating only slightly, but needs to connect to the Rel-17 or Rel-18 donor when migrating far.

In this sense, some “mobile IAB supported” information broadcast from the parent node is required, but whether the mobile IAB node can determine a connectible cell from only such a 1-bit indication is questionable. For example, the indication may be associated with an area in which the mobile IAB node can migrate. However, the indication may mean that an area to which the mobile IAB node is to migrate needs to be determined (or whether the IAB node is considered stationary. For example, according to OAM configurations). In addition, it is worth studying whether there are other cases where the mobile IAB node is allowed to connect to a parent node that does not broadcast the indication. For example, the mobile IAB node may not find the parent node that broadcasts the indication. Accordingly, the RAN2 should discuss in detail what this indication means.

Proposal 9: The RAN2 should agree to introduce some “mobile IAB supported” indication. Further studies are required as to whether the indication is merely a 1-bit indication or whether there is a condition under which the mobile IAB node is granted access to a parent node that does not broadcast the indication.

1. A communication control method used in a cellular communication system, the communication control method comprising:
transmitting, by a network node, a conditional reconfiguration to user equipments; and
executing, by each of the user equipments, a conditional handover after a predetermined amount of time has elapsed since detection of a predetermined condition, wherein
the detection of the predetermined condition is either satisfaction of a trigger condition comprised in the conditional reconfiguration or reception of an execution instruction for the conditional handover from the network node, and
the predetermined amount of time is an amount of time different for each of the user equipments.

2. The communication control method according to claim 1, wherein
the conditional reconfiguration comprises instruction information instructing that the predetermined amount of time from the detection of the predetermined condition to execution of the conditional handover is to be set aside.

3. The communication control method according to claim 1, wherein
the conditional reconfiguration comprises the predetermined amount of time.

4. A communication control method used in a cellular communication system, the communication control method comprising:
configuring, by a network node, Physical Random Access Channel (PRACH) resources for user equipments; and
transmitting, by a user equipment of the user equipments, a PRACH by using a PRACH resource of the PRACH resources configured for the user equipment when executing a conditional handover, wherein
the PRACH resource is a resource different for each of the user equipments.

5. The communication control method according to claim 4, wherein
the transmitting comprises executing, by the user equipment, the conditional handover upon detecting a predetermined condition, and
the detection of the predetermined condition is either satisfaction of a trigger condition comprised in a conditional reconfiguration received from the network node or reception of an execution instruction for the conditional handover from the network node.

6. The communication control method according to claim 5, wherein
the execution instruction comprises instruction information indicating instruction of whether to use the PRACH resource.

7. A communication control method used in a cellular communication system, the communication control method comprising:
transmitting, by user equipments, PRACHs (Msgls) to a target cell when each of the user equipments executes a conditional handover;
transmitting, by the target cell, random access responses (Msg2s) to the user equipments at timings different for each of the user equipments; and
transmitting, by the user equipments, RRC reconfiguration complete (RRCReconfigurationComplete) messages (Msg3s) to the target cell at timings different for each of the user equipments.

8. The communication control method according to claim 7, further comprising
transmitting, to a user equipment of the user equipments by a source cell, a conditional reconfiguration comprising an extended monitoring timer, wherein
the transmitting the PRACHs (Msgls) comprises starting counting the extended monitoring timer when the user equipment starts access to the target cell, and
the transmitting the RRC reconfiguration complete messages (Msg3s) comprises determining that the conditional handover has failed when the user equipment fails to transmit an RRC reconfiguration complete message (Msg3) of the RRC reconfiguration complete messages (Msg3s) even after a count value of the extended monitoring timer reaches an expiry value.
